(19) United States
(12) Patent Application Publication
(10) Pub. No.: US 2026/0264589 A1
(43) Pub. Date: Sep. 10, 2026

(54) VEHICLE SEAT CUSHION

(71) Applicant: MACNEIL IP LLC, Bolingbrook, IL (US)

(72) Inventors: David F. MACNEIL, Fort Lauderdale, FL (US); Stephen KANE, Cedar Lake, IN (US)

(73) Assignee: MACNEIL IP LLC, Bolingbrook, IL (US)

(21) Appl. No.: 19/069,972

(22) Filed: Mar. 4, 2025

(51) Int. Cl. B60N 2/60

(52) U.S. Cl. CPC B60N 2/60

(57) ABSTRACT

A seat cushion for placement on an upholstered seat of a vehicle has a left lower body surface portion and a right lower body surface portion, separated by a center lower body surface portion. The left lower body surface portion is upwardly and leftwardly sloped. The right lower body surface portion is upwardly and rightwardly sloped. The sloped surfaces better conform the lower body surface side bolsters of the upholstered vehicle seat.

### BACKGROUND OF THE INVENTION

The field of the invention relates to automotive aftermarket products, and more particularly to seat cushions for placement on upholstered vehicle seats.

Vehicles, such as cars, trucks and SUVs, almost universally have upholstered or padded seats for the comfort of the driver and passenger(s). These seats rarely are customized for particular drivers or passengers; the upper surface of the horizontal portion or seat pan of the seat always has the same shape. The seat often will have longitudinally oriented bolsters at its sides and also may be concavely curved in a fore and aft or longitudinal direction in a region near its rear margin. This shape may be comfortable for some or even many occupants of the vehicle, but not for all. Further, as time goes on and after the seat is used repeatedly, the seat may become less cushionable, causing more discomfort to the driver or passenger(s). Aftermarket seat cushions exist, but to date their design has been less than optimum with respect to fitting to the upper surface of the vehicle seat.

### SUMMARY OF THE INVENTION

According to one aspect of the invention, a cushion for placement on an upholstered seat of a vehicle has a body with a body lower surface for disposal adjacent an upper surface of the seat. The body lower surface has a body lower surface center portion, a body lower surface left portion disposed between the body lower surface center portion and a left margin of the body, and a body lower surface right portion disposed between the body lower surface center portion and a right margin of the body. The body lower surface left portion is leftwardly and upwardly sloped, while the body lower surface right portion is rightwardly and upwardly sloped, such that the body lower surface better conforms to a vehicle seat having longitudinally-oriented side bolsters.

In one embodiment, the body is molded of a foamed elastomer, such as polyurethane. In one embodiment, the body lower surface center portion may be planar. In these or other embodiments, the body upper surface may comprise a body upper surface center portion, a body upper surface right portion disposed between the body upper surface center portion and the right margin of the body, and a body upper surface left portion disposed between the body upper surface center portio and the left margin of the body. The body upper surface left portion may be leftwardly and upwardly sloped, while a body upper surface right portion may be rightwardly and upwardly sloped. The slope of the body upper surface left portion may be less that the slope of the body lower surface left portion, and the slope of the body upper surface right portion may be less than the slop of the body lower surface right portion. In one embodiment, the body upper surface center portion may be upwardly convexly curved in transverse-vertical section.

In these or other embodiments, the body upper surface may further comprise a front portion disposed between the body upper surface center portion and a front margin of the body. A thickness of the body in the vertical direction, taken within the front portion, may decrease as a function of the longitudinal distance to the front margin. A transverse-vertical section of the front end portion of the body upper surface may be a straight line.

As so configured, the seat cushion of the invention has a lower surface that better conforms to the bolstered upholstered seats of conventional vehicles, while having an upper surface that better conforms to the sitting driver or passenger.

### BRIEF DESCRIPTION OF THE DRAWINGS

Further aspects of the invention and their advantages can be discerned in the following detailed description as read in conjunction with the drawings of exemplary embodiments, in which like characters denote like parts and in which:

FIG. 1 is a left front top perspective view of one embodiment of a cushion for an upholstered vehicle seat;

FIG. 1A is a frame of reference oriented to the view shown in FIG. 1;

FIG. 2 is a left front bottom perspective view of the embodiment shown in FIG. 1;

FIG. 3 is a transverse vertical sectional view taken substantially along Line 3-3 of FIG. 1;

FIG. 4 is a transverse vertical sectional view taken substantially along Line 4-4 of FIG. 1; and

FIG. 5 is a longitudinal vertical sectional view taken substantially along Line 5-5 of FIG. 1.

### DETAILED DESCRIPTION

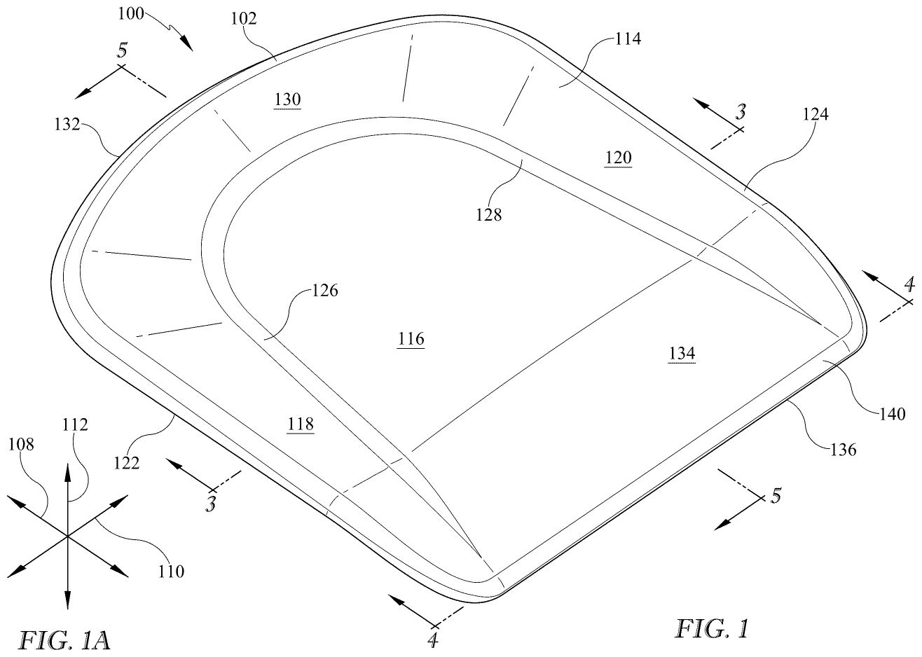

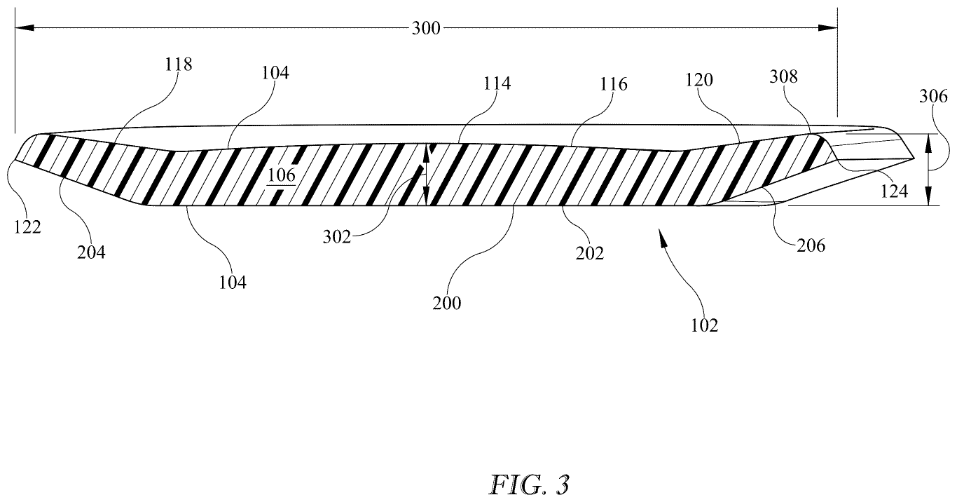

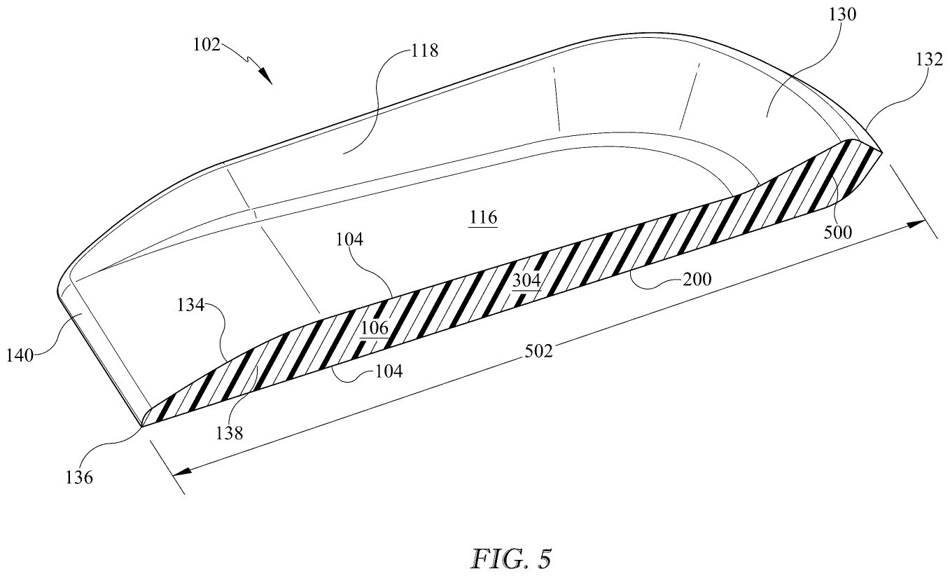

Referring to FIG. 1, a cushion for placement on an upholstered seat of a vehicle is indicated generally at 100. Cushion 100 has a body 102 which may be integrally molded from a foamed elastomer. More particularly, the body 102 may be cast using a molten foaming polyurethane. After hardening, the body 102 will have a fluid-impervious flexible skin 104 and a foamed interior 106 (FIGS. 3 and 5). The body 102 may have a durometer reading of about 18 on the “A” scale, and a density of about 9.7 to 9.8 lbs./ft³.

FIG. 1A is a frame of reference used to describe the cushion 100. A direction 108 is longitudinal or fore-and-aft and, when the cushion 100 is in use, will be aligned with the direction of vehicle travel when the vehicle is moving in a straight line. A direction 110 is transverse, side-to-side or inboard-outboard. Direction 110 is at 90 degrees to direction 108. Directions 108 and 110 reside in a substantially horizontal plane when cushion 100 is in use, although the cushion 100 may be canted so that this plane is tilted. Direction 112 is at 90 degrees to directions 108 and 110 and is substantially vertical.

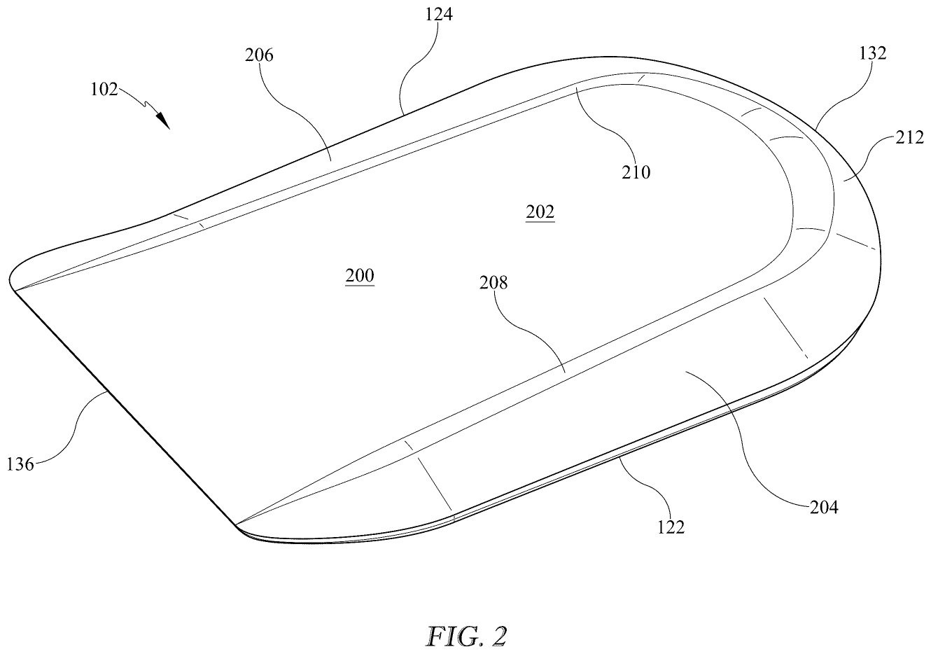

The body 102 has an upper surface 114 (FIG. 1) and a lower surface 200 (FIG. 2). Upper surface 114 has a center portion 116, a left portion 118 and a right portion 120. The left portion 118 is disposed between the center portion 116 and a left margin 122 of the body 102. The right portion 120 is disposed between the center portion 116 and a right margin 124 of the body 102. The left portion 118 and the right portion 120 may be connected to the center portion 116 by relatively thin respective transitional portions 126 and 128.

As best seen in FIG. 3, The center portion 116 of upper surface 114 may be slightly upwardly convexly curved in a transverse-vertical sectional plane, so as to better conform to the anatomy of the human seat. The left portion 118 may be upwardly and leftwardly sloped. The right portion 120 may be upwardly and rightwardly sloped.

Referring back to FIG. 1, a rear portion 130 of the upper surface 114 is disposed between center portion 116 and a rear margin 132 of the cushion body 102. Rear margin 132 may be curved. The rear portion 130 may be upwardly and rearwardly sloped. Surface portion 130 may serve as a continuous curved transition between left surface portion 118 and right surface portion 120. A forward portion 134 of the upper surface 114 may be disposed between center portion 116 and a front margin 136 of the body 102. As best seen in FIG. 5, the surface forward portion 134 is sloped downwardly and forwardly. Forward portion 134 is the upper surface of a body forward region 138, a vertical thickness of which decreases as a function of nearness to forward margin 136.

Referring to FIG. 2, the lower surface 200 has a center portion 202, a left portion 204 and a right portion 206. The left portion 204 of lower surface 200 is disposed between lower surface center portion 202 and the left margin 122. The right portion 206 of lower surface 200 is disposed between lower surface center portion 202 and the right margin 122. The left and right portions 204, 206 may be connected to center portion 202 by respective transitions 208, 210. The lower surface 200 may further have a rear portion 212 that is upwardly concavely curved in both transverse-vertical and longitudinal-vertical sectional planes. Rear portion 212 may provide a smooth curved transition between left surface portion 204 and right surface portion 206.

As seen in FIGS. 2 and 3, the center surface portion 202 may be planar. As seen in FIG. 3, the left bottom surface portion 204 may be upwardly and leftwardly sloped, while the right bottom surface portion 206 may be upwardly and rightwardly sloped. This better fits lower surface 200 to an upholstered vehicle seat having longitudinally disposed side bolsters (not shown). The slope relative to the horizontal of left lower surface portion 204 may be greater than a slop relative to the horizontal of left upper surface portion 118. Similarly, the slope relative to the horizontal of right lower surface portion 206 may be greater than a slope relative to the horizontal of upper right surface portion 120. Portions 204 and 206 may be substantially planar, with the planes thereof canted out of the horizontal.

A maximum transverse width 300 of body 102, from left margin 122 to right margin 124, may be in the range of 17 to 18 inches, and more particularly may be about 17.6 inches. A maximum thickness 302 of a center region 304 beneath center surface portion 116, as measured between surface portion 114 and lower surface portion 202, may be about 1.35 in. A minimum thickness of center region 304 may be about 1.1 in. A total body height 306, measured between bottom center surface portion 202 and a highest ridge 308 on upper surface 114, may be about 1.7 inches.

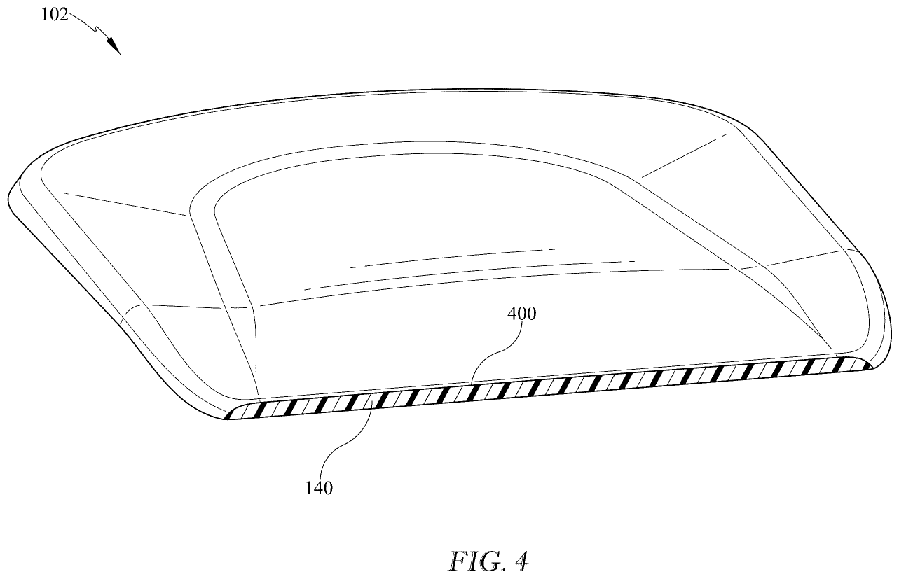

As seen in FIGS. 1 and 5, in one embodiment, the front portion 134 of upper surface 114 forwardly terminates in an end surface portion 140 that is relatively tightly convexly curved in a longitudinal-vertical plane. Upper surface portion 134 may be slightly upwardly convexly curved in a transverse vertical plane, but, as shown in FIG. 4, may transition to a straight line 400 within end surface portion 140.

In FIG. 5, it can been that the thickness of center region 304 stays fairly constant. A thickness of a rear region 500 beneath rear upper surface 130 may be greater than the thickness of center region 304. A maximum length 502, from front margin 136 to rear margin 132, may be in the range of 19 to 20 inches, and more particularly may be about 19.5 inches.

In summary, a cushion has been described and illustrated that may be placed on an upholstered vehicle seat with longitudinally oriented side bolsters. A bottom surface of the cushion body fits to the upholstered vehicle seat, while a top surface thereof fits to the seat of the driver or passenger.

While an embodiment of the present invention have been described and illustrated in the appended drawings, the present invention is not limited thereto but only by the scope and spirit of the appended claims.

We claim:

1. A cushion for placement on an upholstered seat of a vehicle, the cushion comprising:
a body having a body lower surface for disposal adjacent an upper surface of an upholstered seat, a body upper surface opposed to the body lower surface;
the body having a length in a longitudinal direction and a width in a transverse direction at right angles to the longitudinal direction, the longitudinal direction and the transverse direction being at right angles to a vertical direction;
the body having a longitudinally oriented left margin and a longitudinally oriented right margin transversely spaced from the left margin;
the body lower surface having a body lower surface center portion, a body lower surface left portion being disposed between the body lower surface center portion and the left margin, a body lower surface right portion being disposed between the body lower surface center portion and the right margin; wherein
the body lower surface left portion is leftwardly and upwardly sloped, and the body lower surface right portion is rightwardly and upwardly sloped, such that the body lower surface will better conform to an upper surface of an upholstered seat that has longitudinally oriented side bolsters.

2. The cushion of claim 1, wherein the cushion is integrally molded of a foamed elastomer.

3. The cushion of claim 2, wherein the foamed elastomer is polyurethane.

4. The cushion of claim 1, wherein the body lower surface center portion is planar.

5. The cushion of claim 1, system of claim 1, wherein the body lower surface left portion and the body lower surface right portion are respectively connected to the body lower surface center portion by curved transitions.

6. The cushion of claim 1, wherein the body upper surface comprises
a body upper surface center portion,
a body upper surface left portion disposed between the body upper surface center portion and the left margin, the body upper surface left portion being upwardly and leftwardly sloped;
a body upper surface right portion disposed between the body upper surface center portion and the right margin, the body upper surface right potion being upwardly and rightwardly sloped; and
a body upper surface rear portion disposed rearwardly of the body upper surface center portion, the body upper surface rear portion being upwardly and rearwardly sloped and acting as a smooth transition between the body upper surface left portion and the body upper surface right portion.

7. The cushion of claim 6, wherein a slope of the body upper surface left portion is less than a slope of the body lower surface left portion, a slope of the body upper surface right portion being less than a slope of the body lower surface right portion.

8. The cushion of claim 6, wherein the body upper surface center portion is upwardly convexly curved in transverse section.

9. The cushion of claim 8, wherein the body has a front margin and the body upper surface further comprises a front portion disposed between the body upper surface center portion and the front margin, a thickness of the body in the vertical direction decreasing within the front portion as a function of the longitudinal distance to the front margin, a transverse section of the front portion being a straight line.

10. The cushion of claim 6, wherein the body has a front margin and the body upper surface further comprises a front portion disposed between the body upper surface center portion and the front margin, a thickness of the body in the vertical direction decreasing within the front portion as a function of the longitudinal distance to the front margin.
